(19) United States
(12) Patent Application Publication
(10) Pub. No.: US 2024/0270615 A1
(43) Pub. Date: Aug. 15, 2024

(54) SYSTEM AND METHOD FOR REMINERALIZATION OF PURIFIED WATER

(71) Applicant: ACWA POWER Company, Riyadh (SA)

(72) Inventors: Ratul DAS, Makkah (SA); Thomas ALTMANN, Dubai (AE); Muhammad Ghifari RIDWAN, Dubai (AE); Ahmed Yousry Ahmed MAHMOUD, Dubai (AE)

(73) Assignee: ACWA POWER Company, Riyadh (SA)

(21) Appl. No.: 18/438,303

(22) Filed: Feb. 9, 2024

Related U.S. Application Data
(60) Provisional application No. 63/444,777, filed on Feb. 10, 2023.

(51) Int. Cl. C02F 1/68

(52) U.S. Cl. CPC C02F 1/685; C02F 2209/001; C02F 2209/006; C02F 2209/06; C02F 2209/10

(57) ABSTRACT

A system and a method for remineralization of purified water retrieves liquid stream data associated with a first liquid stream that includes a set of chemical compounds and a set of parameters. The system controls a concentration of at least a first chemical compound of the set of chemical compounds by adding at least the first chemical compound to the first liquid stream. The system compares at least a first parameter of the set of parameters with a corresponding reference parameter of a set of reference parameters based on the addition of the first chemical compound. The system also controls the output of the first liquid stream based on the comparison.

### CROSS REFERENCE TO RELATED APPLICATION

This application claims priority to U.S. Provisional Patent Application Ser. No. 63/444,777, filed Feb. 10, 2023, and entitled “SYSTEM AND METHOD FOR REMINERALIZATION OF PURIFIED WATER”, the disclosure of which is incorporated herein by reference.

### TECHNICAL FIELD

This disclosure relates to the field of liquid treatment. More specifically, the present disclosure relates to the seawater reverse osmosis (SWRO) system for remineralization of purified water.

### BACKGROUND

In recent years, the global issue of shortage of freshwater has been increasing rapidly. The shortage of freshwater is a major problem owing to extreme weather conditions, desertification, and water pollution. As freshwater nourishes and sustains life, incessant population growth demands a greater supply of freshwater. To meet the increasing demand for freshwater, seawater reverse osmosis (SWRO) is being widely used technology to produce freshwater from seawater which is present abundantly on the earth. The SWRO process takes place in a seawater reverse osmosis (SWRO) plant. Such SWRO plants include multiple components such as pumps, membranes, valves, energy recovery devices, and the like. The SWRO process can be complex, counterintuitive, as well as energy-intensive. The purified water produced by the SWRO membranes needs to be re-mineralized to be compliant with the regulatory water quality requirements. The process needs to be optimized to meet the specific requirements of minerals in purified water.

Furthermore, due to periodic changes in seawater quality and weather conditions, the operating parameters in a seawater reverse osmosis (SWRO) process need continuous monitoring to minimize energy consumption and optimize the use of chemicals such that product water quality requirements are met. Therefore, there is a requirement for an optimization process for re-mineralization of reverse osmosis (RO) purified water produced from the SWRO process.

### SUMMARY

In comparison with the traditional techniques, the present disclosure provides an improved design of a system and a method for the remineralization of purified water produced from the seawater reverse osmosis (SWRO) process.

A system and method are provided herein that focuses on the optimization and design of the SWRO process with the facilitation of continuously monitoring the re-mineralized water quality and controlling the quality parameters.

In one aspect, a system for remineralization of purified water is provided. The system may include a memory that may be configured to execute the computer-executable instructions that cause the one or more processors to retrieve liquid stream data associated with a first liquid stream including a set of chemical compounds. The liquid stream data includes a set of parameters. The processor may be further configured to control a concentration of at least a first chemical compound of the set of chemical compounds in the first liquid stream by adding at least the first chemical compound in the first liquid stream. The processor may be further configured to compare at least a first parameter of the set of parameters with a corresponding reference parameter of a set of reference parameters based on the addition of at least the first chemical compound in the first liquid stream and control an output of the first liquid stream based on the comparison.

In an embodiment, the set of parameters are associated with at least one of a chemical composition for each of the set of chemical compounds in the first liquid stream, a potential of hydrogen (pH) of the first liquid stream, a total dissolved solids (TDS) of the first liquid stream, or one or more water quality parameters of the first liquid stream.

In another embodiment, the processor may be further configured to determine a quality score for the first liquid stream based on the set of parameters and control the output of the first liquid stream based on the determined quality score.

In another embodiment, the set of reference parameters are associated with at least one of a chemical composition for each of the set of chemical compounds in a reference liquid stream, a pH of the reference liquid stream, a TDS of the reference liquid stream, or one or more water quality parameters of the reference liquid stream.

In an embodiment, the processor may be further configured to determine whether at least the first parameter of the set of parameters is within a first threshold range. The first threshold range includes at least a minimum value of the corresponding reference parameter, and a maximum value of the corresponding reference parameter.

In another embodiment, the processor may be further configured to control the output of the first liquid stream based on a determination that at least the first parameter of the set of parameters lies within the first threshold range. The output corresponds to a storage of the first liquid stream.

In yet another embodiment, the processor may be further configured to control the output of the first liquid stream based on a determination that at least the first parameter of the set of parameters is greater than the maximum value of the corresponding reference parameter, or less than the minimum value of the corresponding reference parameter. The output corresponds to the addition of at least the first chemical compound of the set of chemical compounds in the first liquid stream iteratively until at least the first parameter of the set of parameters is within the first threshold range.

In an embodiment, the processor may be configured to retrieve the pH data of the first liquid stream based on the liquid stream data. Further, the processor may be configured to control the concentration of at least the first chemical compound of the set of chemical compounds in the first liquid stream based on the pH data.

In another embodiment, the processor may be configured to determine whether the pH data of the first liquid stream is within a second threshold range. The second threshold range includes at least a minimum pH value of the first liquid stream, and a maximum pH value of the first liquid stream, wherein the minimum pH value and the maximum pH value of the first liquid stream are determined based on pH data in the set of reference parameters. Further, the processor may be configured to control the output of the first liquid stream based on the determination.

In another embodiment, the processor may be further configured to retrieve saturation index data for the first liquid stream based on the set of parameters. Further, the processor may be configured to control the concentration of at least the first chemical compound of the set of chemical compounds in the first liquid stream based on the saturation index data.

In yet another embodiment, the processor may be further configured to determine whether the saturation index data for the first liquid stream is within a third threshold range. The third threshold range includes at least a minimum saturation index value for the first liquid stream and a maximum saturation index value for the first liquid stream. The minimum saturation index value and the maximum saturation index value are determined based on the saturation index data included in the set of reference parameters. The processor may be further configured to control the output of the first liquid stream based on the determination.

In an embodiment, the processor may be further configured to control one or more valves to adjust the flow of the first liquid stream to add at least the first chemical compound.

In another aspect, a method for remineralization of purified water is provided. The method may include retrieving liquid stream data associated with a first liquid stream which includes a set of chemical compounds. The liquid stream data includes a set of parameters. The method may further include controlling a concentration of at least a first chemical compound of the set of chemical compounds in the first liquid stream by modifying at least the first chemical compound in the first liquid stream. The method may further include comparing at least a first parameter of the set of parameters with a corresponding reference parameter of a set of reference parameters based on the modification of at least the first chemical compound in the first liquid stream. The method may further include controlling an output of the first liquid stream based on the comparison.

In one method embodiment, the method may include determining a quality score for the first liquid stream based on the set of parameters. The method may further include controlling the output of the first liquid stream based on the determined quality score.

In another method embodiment, the method may include determining whether at least the first parameter of the set of parameters is within a first threshold range. The first threshold range includes at least a minimum value of the corresponding reference parameter, and a maximum value of the corresponding reference parameter.

In another method embodiment, the method may include controlling the output of the first liquid stream based on a determination that at least the first parameter of the set of parameters lies within the first threshold range. The output corresponds to a storage of the first liquid stream.

In yet another method embodiment, the method may include controlling the output of the first liquid stream based on a determination that at least the first parameter of the set of parameters is greater than the maximum value of the corresponding reference parameter, or less than the minimum value of the corresponding reference parameter. The output corresponds to the addition of at least the first chemical compound of the set of chemical compounds in the first liquid stream iteratively until at least the first parameter of the set of parameters is within the first threshold range.

In another method embodiment, the method may include retrieving pH data of the first liquid stream based on the liquid stream data. The method may further include controlling the concentration of at least the first chemical compound of the set of chemical compounds in the first liquid stream based on the pH data.

In another method embodiment, the method may include retrieving saturation index data for the first liquid stream based on the set of parameters. The method may further include controlling the concentration of at least the first chemical compound of the set of chemical compounds in the first liquid stream based on the saturation index data.

In yet another aspect, a non-transitory computer-readable storage medium carrying one or more sequences of one or more instructions which, when executed by at least one processor, cause an apparatus to perform operations comprising, retrieving liquid stream data associated with a first liquid stream which includes a set of chemical compounds, wherein the liquid stream data includes a set of parameters. The operations may further include controlling a concentration of at least a first chemical compound of the set of chemical compounds in the first liquid stream by adding at least the first chemical compound in the first liquid stream. The operations may further include comparing at least a first parameter of the set of parameters with a corresponding reference parameter of a set of reference parameters based on the addition of at least the first chemical compound in the first liquid stream. The operations may further include controlling an output of the first liquid stream based on the comparison.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 is a diagram that illustrates a network environment in which a system for the remineralization of purified water is implemented, in accordance with an embodiment of the disclosure;

FIG. 2 illustrates a block diagram of the system of FIG. 1, in accordance with an embodiment of the disclosure;

FIG. 3 illustrates an exemplary network environment in which the system of FIG. 1 is implemented, in accordance with an embodiment of the disclosure;

FIG. 4 is a diagram that illustrates exemplary operations for the remineralization of purified water, in accordance with an embodiment of the disclosure;

FIG. 5 is a diagram that illustrates an exemplary flowchart describing an algorithm to optimize chemical dosing for the remineralization of purified water, in accordance with an embodiment of the disclosure; and

FIG. 6 is a flowchart that illustrates an exemplary method for remineralization of purified water, in accordance with an embodiment of the disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

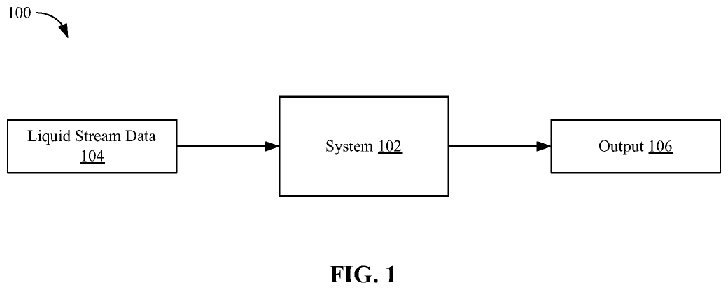

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect. Turning now to FIG. 1-FIG. 6, a brief description concerning the various components of the present disclosure will now be briefly discussed. Reference will be made to the figures showing various embodiments of a system for remineralization of purified water.

FIG. 1 is a diagram that illustrates a network environment in which a system for remineralization of purified water is implemented, in accordance with an embodiment of the disclosure. With reference to FIG. 1, there is shown a network environment 100. The network environment 100 may include a system 102 which may be used for remineralization of purified water to produce potable water.

The system 102 may correspond to a remineralization system that may have the capability of re-mineralizing purified water and correcting a concentration of minerals in the purified water, thereby providing better output of the seawater reverse osmosis (SWRO) process. The system 102 may enhance data acceptability, minimize deviations, and standardize the quality of the purified water. In an embodiment, the system 102 may correspond to a simulation system for simulating the operation of an entire SWRO plant. For example, the system 102 may correspond to a computer executable algorithm to achieve one or more functions of the remineralization system. Examples of the system 102 may be, for example, but not limited to, a reverse osmosis simulation system, a multi-stage flash distillation simulation system, a multiple effect distillation simulation system, and an electrodialysis reversal simulation system.

In operation, the system 102 may be configured to retrieve the liquid stream data 104 associated with the first liquid stream including a set of chemical compounds. In an embodiment, the first liquid stream may be, for example, freshwater, permeate water, or potable water. The liquid stream data 104 may include the set of parameters. The set of parameters may be associated with at least one of a chemical composition of each of the set of chemical compounds in the first liquid stream, a potential of hydrogen (pH) of the first liquid stream, a total dissolved solids (TDS) of the first liquid stream, or one or more water quality parameters of the first liquid stream.

In an embodiment, the system 102 may be configured to determine the chemical composition of each of the set of chemical compounds in the first liquid stream. The set of chemical compounds may include, but are not limited to, carbon dioxide (CO₂), lime (Ca(OH)₂) water, Limestone (CaCO₃), sodium fluoride (NaF), sodium hydroxide (NaOH), sodium hypochlorite (NaOCl), calcium hypochlorite (Ca(OCl)₂), and chlorine dioxide (ClO₂).

The system 102 may be configured to control the concentration of at least a first chemical compound of the set of chemical compounds in the first liquid stream by adding at least the first chemical compound in the first liquid stream. The system 102 may be further configured to compare at least a first parameter of the set of parameters with a corresponding reference parameter of a set of reference parameters based on the addition of at least the first chemical compound in the first liquid stream.

In an embodiment, the system 102 may compare liquid stream data 104 to reference data to perform accuracy checks thereby producing the first liquid stream. Specifically, the system 102 may be configured to dose a demineralized first liquid stream with the chemical compounds in order to re-mineralize the first liquid stream. The first liquid stream may correspond to a permeate liquid stream. Further, the permeate liquid stream may correspond to desalinated water that is demineralized or deionized in an RO system. For example, the system 102 may be configured to perform remineralization of the desalinated water by dosing carbon dioxide (CO₂), lime (Ca(OH)₂) water, Limestone (CaCO₃), sodium fluoride (NaF), sodium hydroxide (NaOH), sodium hypochlorite (NaOCl), calcium hypochlorite (Ca(OCl)₂), and chlorine dioxide (ClO₂) in the permeate liquid stream. In general, the purpose of the remineralization process is to replenish levels of calcium hardness and alkalinity in the permeate liquid stream. The remineralization is performed to deliver an on-specification water quality that is safe for human consumption and non-aggressive to water distribution infrastructure.

Further, the system 102 may be further configured to control an output 106 of the first liquid stream based on the dosing of the chemical compounds. For example, the output 106 may correspond to storing a re-mineralized permeate liquid stream in a storage unit, but not limited to, a water tank.

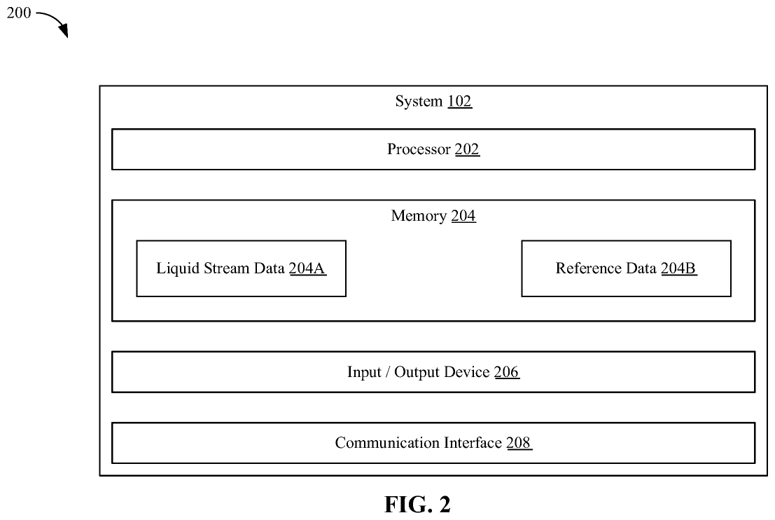

FIG. 2 illustrates a block diagram of the system of FIG. 1, in accordance with an embodiment of the disclosure. FIG. 2 is explained in conjunction with FIG. 1. In FIG. 2, there is shown the block diagram 200 of the system 102. The system 102 may include at least one processor (referred to as a processor 202, hereinafter), at least one non-transitory memory (referred to as a memory 204, hereinafter), an input/output (I/O) interface 206, and a communication interface 208. The memory 204 may further include the liquid stream data 204A and reference data 204B. The processor 202 may be connected to the memory 204, the I/O interface 206, and the communication interface 208 through one or more wired or wireless connections. Although in FIG. 2, it is shown that the system 102 includes the processor 202, the memory 204, the I/O interface 206, and the communication interface 208 however, the disclosure may not be so limiting and the system 102 may include fewer or more components to perform the same or other functions of the system 102.

The processor 202 of the system 102 may be configured to perform one or more operations associated with the remineralization of purified water. The processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the system 102.

For example, when the processor 202 may be embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202. The communication network may be accessed using the communication interface 208 of the system 102. The communication interface 208 may provide an interface for accessing various features and data stored in the system 102.

The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the system 102 to carry out various functions in accordance with an example embodiment of the present disclosure. For example, the memory 204 may be configured to buffer input data for processing by the processor 202. As exemplified in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an Application Specific Integrated Circuit (ASIC), Field Programmable Gate Array (FPGA), or the like, the processor 202 may be specifically configured hardware for conducting the operations described herein. In an embodiment, memory may be configured to store the liquid stream data 204A and the reference data 204B.

In an embodiment, the processor 202 may be configured to retrieve the liquid stream data 204A and store the liquid stream data 204A in the memory 204. The liquid stream data 204A may be associated with the first liquid stream that may correspond to the permeate water. In another embodiment, the processor 202 may be configured to retrieve the reference data 204B and store the reference data 204B in the memory 204. The reference data 204B may be associated with the reference liquid stream that may correspond to the sample potable water.

In some example embodiments, the I/O interface 206 may communicate with the system 102 and display the input and/or output of the system 102. As such, the I/O interface 206 may include a display and, in some embodiments, may also include a keyboard, a mouse, a touch screen, touch areas, soft keys, or other input/output mechanisms. In one embodiment, the system 102 may include a user interface circuitry configured to control at least some functions of one or more I/O interface elements such as a display and, in some embodiments, a plurality of speakers, a ringer, one or more microphones and/or the like. The processor 202 and/or I/O interface 206 circuitry including the processor 202 may be configured to control one or more functions of one or more I/O interface 206 elements through computer program instructions (for example, software and/or firmware) stored on a memory 204 accessible to the processor 202.

The communication interface 208 may include the input interface and output interface for supporting communications to and from the system 102 or any other component with which the system 102 may communicate. The communication interface 208 may be any means such as a device or circuitry embodied in either hardware or a combination of hardware and software that is configured to receive and/or transmit data to/from a communications device in communication with the system 102. In this regard, the communication interface 208 may include, for example, an antenna (or multiple antennae) and supporting hardware and/or software for enabling communications with a wireless communication network. Additionally, or alternatively, the communication interface 208 may include the circuitry for interacting with the antenna(s) to cause transmission of signals via the antenna(s) or to handle receipt of signals received via the antenna(s). In some environments, the communication interface 208 may alternatively or additionally support wired communication. As such, for example, the communication interface 208 may include a communication modem and/or other hardware and/or software for supporting communication via cable, digital subscriber line (DSL), universal serial bus (USB), or other mechanisms.

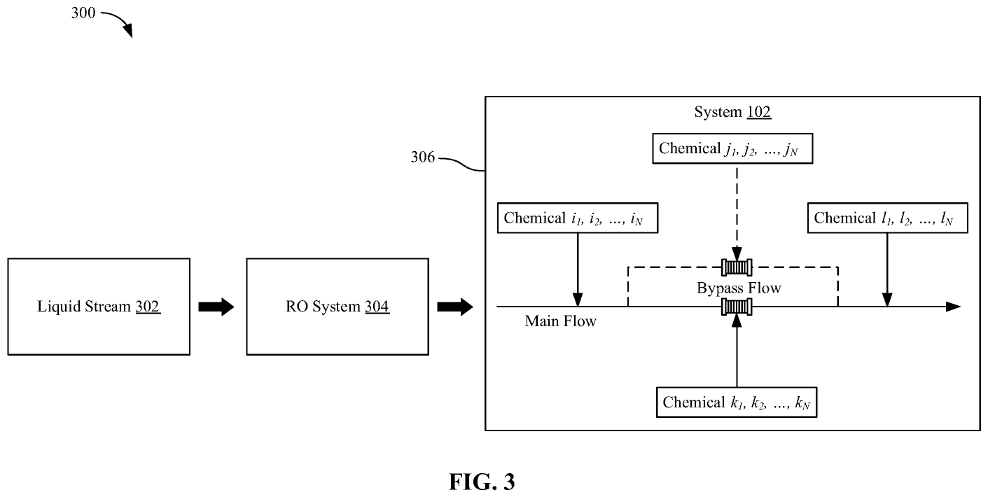

FIG. 3 illustrates an exemplary network environment in which the system of FIG. 1 is implemented, in accordance with an embodiment of the disclosure. FIG. 3 is explained in conjunction with FIG. 1 and FIG. 2. In FIG. 3, there is shown a network environment 300. The network environment 300 may include a liquid stream 302, an RO system 304 and the system 102.

In an embodiment, the liquid stream 302 may be provided as an input to the RO system 304. The RO system 304 may be configured to receive the liquid stream 302 from various sources. Examples of such sources may include, but are not limited to, a storage tank, an open inlet, an open seawater intake pipe, and a beach well. The liquid stream 302 for example, but is not limited to, the seawater or saltwater. For example, a Total Dissolved Solids (TDS) value for the liquid stream 302 may range from 37,000 to 50,000 milligrams per liter (mg/l). Further, a Potential of Hydrogen (pH) value of the liquid stream 302 may lie within a range of 7 to 8.6. Additionally, the liquid stream 302 may have a high salt content, thereby making the liquid stream 302 unsafe for human use.

Conventionally, a seawater desalination technique may be employed to obtain the first liquid stream by removing excessive salt content from the liquid stream 302. The first liquid stream may be, but is not limited to, the freshwater, permeate water, or potable water. The pH value of the first liquid stream may lie within the range of 5 to 7.2, making the first liquid stream fit for human consumption. Examples of various methods of treatment of the seawater desalination may include but are not limited to evaporation of liquid stream 302 and a membrane separation method based on differential and selective permeation ability of the membrane. For example, the membrane separation method may correspond to a reverse osmosis (RO) process. The reverse osmosis may refer to a technique by which the freshwater (such as the first liquid stream) is extracted by the application of higher than osmotic pressure of the seawater (such as the liquid stream 302) with a semipermeable membrane interposed in between. The seawater reverse osmosis (SWRO) technique may employ the use of semi-permeable membranes that allow a solvent to pass through, while restricting solutes (such as impurities), leading to the separation of salt and freshwater.

In general, the principle of the SWRO process is osmosis. Further, osmosis is a process where low-salinity and high-salinity water are separated by a semi-permeable membrane, and water transfers through the membrane from the low-salinity side to the high-salinity side. The transfer of water in one direction builds up a net pressure on the high-salinity side, which is called osmotic pressure. If a pressure is applied to the high-salinity side that exceeds the osmotic pressure, then water will transfer faster from the high-salinity side to the low-salinity side. This process is called reverse osmosis, and the transferred water is relatively pure compared to the original seawater.

In operation, the RO system 304 may receive a pre-treated liquid stream 302 (or the liquid stream 302) as an input. The pre-treated liquid stream 302 may correspond to a standardized seawater for utilization in SWRO plant designs thereby obtaining the best possible operating parameters in SWRO at minimum energy consumption. Further, the RO system 304 may include various systems and apparatuses for the purification of the liquid stream 302. For example, the RO system 304 may be a two-pass RO system.

In an embodiment, the system 102 may be configured to receive purified water (such as the first liquid stream) from the RO system 304. The first liquid stream from the RO system 304 may correspond to desalinated water including water molecules with very low concentration dissolved salts and minerals. Further, the concentration of ions may be less than standardized seawater. In general, desalination is a process by which the dissolved mineral salts, and impurities in seawater are removed. Further, desalination plants use a RO process in which seawater is pumped into the desalination plant from the seawater resources and pre-treatment filtration is performed to remove most particles.

To overcome such problems, the desalinated water may undergo treatment to adjust mineral content and improve its taste. In general, the process of water remineralization is a method of adjusting the mineral content of the drinking water to the level recommended for consumer health. To adjust the mineral content of water, combination of the one or more chemicals described above, and carbon dioxide are injected to reach the required level.

The system 102 may be configured to re-mineralize the purified water. In an example, the system 102 may correspond to a post-treatment facility to prepare potable water by dosing the purified water with the set of chemical compounds. In such an example, the system 102, may be further connected to a water treatment plant which typically has a reservoir system in line with a water purification or treatment apparatus such as, but not limited to, RO device, static mixer, high pressure pumps, energy recovery devices (ERD) etc. The system 102 may be further configured to control a water tank connected in line in or with the water treatment plant to receive the re-mineralized water (such as the first liquid stream, or potable water).

Further, the system 102 may include flexible configurations. As shown in the FIG. 3, the system 102 may have a bypass configuration 306. In an embodiment, the system 102 may be configured to control one or more valves to adjust flow of the first liquid stream to add at least the first chemical compound. For example, the system 102 may be configured to control a flow of a portion of the first liquid stream in order to send the permeate water to an off-spec pipe (such as, an off-spec pipe depicted by dashed lines). The system 102 may further redirect the flow, once the permeate water reaches a desired specification, in order to send the permeate water back to a potable water tank. In the former event, the system 102, diverts the full flow of water to an off-spec pipe, automatically or via manual input.

In an embodiment, the system 102 configuration enables optimizing dosing of different chemical compounds, such as a chemical i₁, a chemical j₁, a chemical k₁, and a chemical l₁. The number of chemical compounds for dosing optimization are shown as four for only exemplary purposes and should not be construed to be limiting the scope of the present disclosure. It may be understood by one of ordinary skill in the art that fewer or a greater number of chemical compounds may be equivalently used in the system 102, without deviating from the scope of the present disclosure.

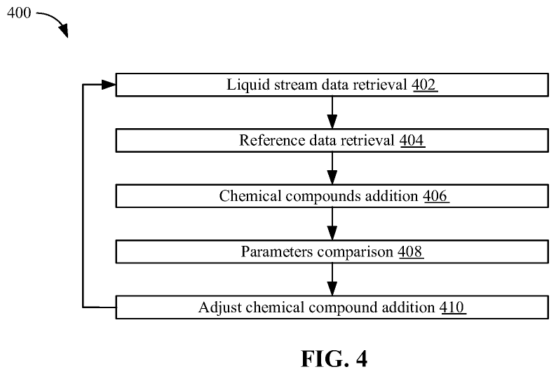

FIG. 4 is a diagram that illustrates exemplary operations for remineralization of purified water, in accordance with an embodiment of the disclosure. FIG. 4 is explained in conjunction with FIG. 1, FIG. 2, and FIG. 3. In FIG. 4 there is shown a flowchart 400 of the system 102 for remineralization of the purified water.

At 402, liquid stream data 104 may be retrieved. In an embodiment, the processor 202 may be configured to retrieve liquid stream data 104 associated with a first liquid stream comprising a set of chemical compounds. The liquid stream data 104 may include a set of parameters. The system 102 may further include a plurality of sensors for measuring at least one parameter of the first liquid stream. In an embodiment, the set of parameters are associated with at least one of: a chemical composition for each of the set of chemical compounds in the first liquid stream, a potential of hydrogen (pH) of the first liquid stream, a total dissolved solids (TDS) of the first liquid stream, or one or more water quality parameters of the first liquid stream.

In an example, the chemical composition for each of the set of chemical compounds in the first liquid stream may correspond to a concentration of each of the set of chemical compounds (such as salts and minerals). The set of chemical compounds may include but is not limited to sodium, chloride, calcium, magnesium, and sulphate.

In another example, the TDS of the first liquid stream may correspond to a total amount of solids that may be dissolved in the first liquid stream, including soluble hydrogen carbonate ions, chloride salts, sulphates, calcium, magnesium, sodium, potassium, volatile solids and non-volatile solids. In an exemplary embodiment, the system 102 may be configured to determine the sum of chemical composition of each chemical compound of the set of chemical compounds of the first liquid stream. The determined sum is the TDS of the first liquid stream.

In an example, the one or more water quality parameters of the first liquid stream may include, but not limited to at least one of: physical parameter, chemical parameters and biological parameters. The physical parameters may include, but are not limited to colour, taste, odour, temperature, turbidity, solids, and electrical conductivity. The chemical parameters may include, include, but are not limited to pH, acidity, alkalinity, chlorine, hardness, dissolved oxygen, and biological oxygen. The biological parameters, may include, but are not limited to bacteria, algae, and viruses.

In an example, the processor 202 may be configured to determine dissolved inorganic carbon in the first liquid stream based on continuous online data of the potable water.

Such dissolved inorganic carbon is a parameter that quantifies the amount of inorganic carbon dissolved in water including carbonates (CO₃²⁻), bicarbonates (HCO₃⁻), and dissolved carbon dioxide (CO₂).

At 404, reference data may be retrieved. In an embodiment, the processor 202 may be configured to retrieve reference data 204B associated with a reference liquid stream. Further, the reference data 204B may include a set of reference parameters. In an exemplary embodiment, the reference liquid stream may be, for example, but not limited to, potable water with desired specification. The set of reference parameters are associated with at least one of: a chemical composition for each of the set of chemical compounds in a reference liquid stream, a pH of the reference liquid stream, a TDS of the reference liquid stream, a charge balance of the set of chemical compounds in the reference liquid stream, one or more water quality parameters of the reference liquid stream, or a chloride ion ratio of the reference liquid stream.

In an example, the processor 202 may be configured to determine dissolved inorganic carbon in the reference liquid stream based on continuous online data of the potable water. Such dissolved inorganic carbon is a parameter that quantifies the amount of inorganic carbon dissolved in water including carbonates (CO₃²⁻), bicarbonates (HCO₃⁻), and dissolved carbon dioxide (CO₂). In an embodiment, the processor 202 may be configured to provide continuous data of potable water quality with the current unoptimized dosing rate for the set of chemical compounds for the first liquid stream (such as the permeate water), which is received from the RO system 304. The desalinated water that is demineralized or deionized in RO system 304, is called permeate water. The set of chemical compounds may include but are not limited to carbon dioxide (CO₂), lime (Ca(OH)₂) water, Limestone (CaCO₃), sodium fluoride (NaF), sodium hydroxide (NaOH), sodium hypochlorite (NaOCl), calcium hypochlorite (Ca(OCl)₂), and chlorine dioxide (ClO₂).

At 406, first chemical compound may be added. In an embodiment, the processor 202 may be configured to control a concentration of at least a first chemical compound of the set of chemical compounds in the first liquid stream by adding at least the first chemical compound in the first liquid stream. In an example, the re-mineralization process includes flexibility in terms of dosing different chemical compounds including carbon dioxide (CO₂), lime (Ca(OH)₂) water, Limestone (CaCO₃), sodium fluoride (NaF), sodium hydroxide (NaOH), sodium hypochlorite (NaOCl), calcium hypochlorite (Ca(OCl)₂), and chlorine dioxide (ClO₂) in the first liquid stream. In operation, the system 102 may receive purified water (such as the first liquid stream) from seawater reverse osmosis (SWRO) membranes (such as the RO system 304). Thereafter, the processor 202 may be configured to dose at least the first chemical compound into the purified water in order to re-mineralize the purified water.

In an example, the processor 202 may be configured to initialize the re-mineralization dosing rate. Specifically, the processor 202 may be configured to dose the first liquid stream with an assumed concentration of at least the first chemical compound of the set of chemical compounds in the first liquid stream. Such remineralization dosing is initialized based on a minimum potable water requirement. The set of chemical compounds for remineralization may include but are not limited to sodium fluoride (NaF), limestone (CaCO₃), and lime (Ca(OH)₂).

In an example, the processor 202 may be configured to injecting CO₂ together with limewater, limestone filter, and/or sodium fluoride for remineralization. In another example, the processor 202 may be configured to add caustic soda for pH adjustment prior before storage in a remineralization water tank. In yet another example, the processor 202 may be configured to dose sodium hypochlorite, calcium hypochlorite, and/or chlorine dioxide in the first liquid stream for disinfection.

At 408, the first parameter may be compared. In an embodiment, the processor 202 may be configured to compare at least a first parameter of the set of parameters with a corresponding reference parameter of a set of reference parameters based on the addition of at least the first chemical compound in the first liquid stream. Upon the retrieval of the liquid stream data 104 and the reference stream data, the processor 202 may compare the first parameter of the set of parameters associated with the first liquid stream with the corresponding parameter of the set of reference parameters.

For example, in a case where the first parameter of the set of parameters may be the chemical composition for each of the set of chemical compounds associated with the first liquid stream, the processor 202 may be configured to compare the chemical composition for each of the set of chemical compounds with the chemical composition of the corresponding chemical compound of the set of chemical compounds associated with the reference liquid stream.

At 410, an addition of the chemical compound may be adjusted. In an embodiment, the processor 202 may be configured to adjust the concentration of at least the first chemical compound of the set of chemical compounds in the first liquid stream based on the comparison. In an example, the processor 202 may be configured to determine optimized dosing quantities for the set of chemical compounds. The determination of the optimized dosing quantities may be an iterative process. Based on the identified optimized dosing quantities, the processor 202 may be configured to adjust the chemical dosing of the system 102 by controlling the flow of at least the first chemical compound.

In an embodiment, after the readjustment of the flow of at least the first chemical compound, the processor 202 may be configured to again measure the liquid stream data 104 of the re-mineralized water at 402, and this process is done iteratively until the re-mineralized water quality reaches the desired or standard specifications that are suitable for potable use and at the same time, which minimizes chemical dosing, and optimizes energy consumption in the RO system 304.

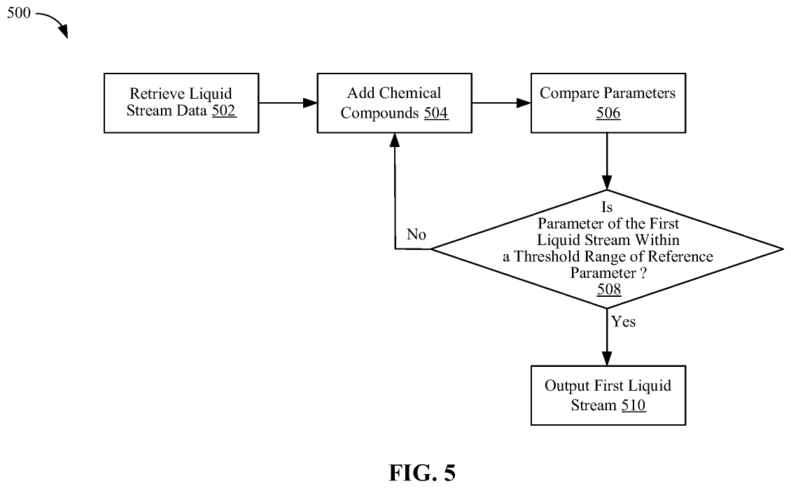

FIG. 5 is a diagram that illustrates an exemplary flowchart describing an algorithm to optimize chemical dosing for remineralization of purified water, in accordance with an embodiment of the disclosure. FIG. 5 is explained in conjunction with elements from FIGS. 1, 2, 3, and 4. In FIG. 5 there is shown an exemplary flowchart 500 of the system 102 for remineralization of the purified water.

At 502, liquid stream data 104 may be retrieved. In an embodiment, the processor 202 may be configured to retrieve liquid stream data 104 associated with a first liquid stream including a set of chemical compounds. The liquid stream data 104 may include a set of parameters. Details associated with the retrieval of the liquid stream data 104 are provided in FIG. 4.

At 504, the first chemical compound may be added. In an embodiment, the processor 202 may be configured to control a concentration of at least the first chemical compound of the set of chemical compounds in the first liquid stream by adding at least the first chemical compound in the first liquid stream. Details associated with the addition of the first chemical compound are provided in FIG. 4.

At 506, the first parameter may be compared. In an embodiment, the processor 202 may be configured to compare at least a first parameter of the set of parameters with a corresponding reference parameter of a set of reference parameters based on the addition of at least the first chemical compound in the first liquid stream. Details associated with the comparison of the first parameter are provided in FIG. 4.

At 508, it may be determined whether or not a first parameter of the first liquid stream is within a first threshold range. In an embodiment, the processor is further configured to determine whether at least the first parameter of the set of parameters is within a first threshold range. The first threshold range may include at least a minimum value of the corresponding reference parameter, and a maximum value of the corresponding reference parameter.

In an example, the first parameter may correspond to the TDS of the first liquid stream, and the processor may be configured to determine whether the TDS of the first liquid stream is within a first threshold range. In such an example, the first threshold range may be indicative of a minimum TDS value, and a maximum TDS value based on the TDS requirement of the potable water. For example, if the TDS of the reference liquid stream may correspond to a value ‘X’, and the tolerance value may correspond to +/−5%. In such a scenario, the minimum TDS value may correspond to ‘X−5%’, and the maximum TDS value may correspond to ‘X+5%’.

At 510, output the first liquid stream. In an embodiment, the processor 202 may be configured to control the output 106 of the first liquid stream based on the determination. In an embodiment, the processor 202 may be configured to control the output 106 of the first liquid stream based on a determination that at least the first parameter of the set of parameters lies within the first threshold range. In such an embodiment, the output 106 corresponds to a storage of the first liquid stream. The output 106 may correspond to sending the re-mineralized water to water tanks.

Alternatively, the processor 202 may be configured to control the output 106 of the first liquid stream based on a determination that at least the first parameter of the set of parameters is greater than the maximum value of the corresponding reference parameter, or less than the minimum value of the corresponding reference parameter. In such a case, the output 106 corresponds to the addition of at least the first chemical compound of the set of chemical compounds in the first liquid stream iteratively until at least the first parameter of the set of parameters is within the first threshold range. In an example, the first parameter may correspond to the TDS of the first liquid stream, and the processor 202 may be configured to determine whether the TDS of the first liquid stream is beyond the first threshold range associated with the potable water requirement. The processor 202 may be configured to initialize the remineralization dosing rate. In this step, the remineralization dosing is initialized based on the minimum potable water requirement. The chemicals for remineralization include sodium fluoride (NaF), limestone (CaCO3), and lime (Ca(OH)2).

In an embodiment, the optimum dosing rate of the set of chemical compounds may be re-calculated using an iterative method. As a result, the remineralization of permeate water may be performed as per embodiments described above, until the water quality is enhanced while minimizing chemical dosing and reducing energy consumption of the RO system 304 used for the treatment of the seawater.

In an embodiment, the processor 202 may be configured to retrieve the pH data of the first liquid stream based on the liquid stream data 104. Thereafter, the processor 202 may be configured to control the concentration of at least the first chemical compound of the set of chemical compounds in the first liquid stream based on the pH data. In an embodiment, the processor 202 may be configured to determine whether the pH data of the first liquid stream is within a second threshold range. The second threshold range may include at least a minimum pH value of the first liquid stream, and a maximum pH value of the first liquid stream. In such a scenario, the minimum pH value, and the maximum pH value of the first liquid stream are determined based on pH data in the set of reference parameters. Thereafter, the processor 202 may be configured to control the output 106 of the first liquid stream based on the determination.

For example, the processor 202 may be configured to control the output 106 of the first liquid stream based on a determination that the pH data of the first liquid stream lies within the second threshold range. In such an embodiment, the output 106 corresponds to a storage of the first liquid stream. The output 106 may correspond to sending the re-mineralized water to water tanks. Alternatively, the processor 202 may be configured to control the output 106 of the first liquid stream based on a determination that the pH data of the first liquid stream is beyond the second threshold range associated with the potable water requirement. In such a case, the output 106 corresponds to the addition of at least the first chemical compound of the set of chemical compounds in the first liquid stream iteratively until the pH data is within the second threshold range.

In an example, the processor 202 may be configured to reduce the pH value of the permeate water (the first liquid stream) by adding carbon dioxide (CO₂). The pH value is a measure of how acidic/basic water is. The range goes from 0 to 14, with 7 being neutral. A pH value of less than 7 indicates the water is acidic, whereas a pH value greater than 7 indicates the water is alkaline or basic. The pH value of water may be a very important measurement concerning water quality. For example, adding CO₂ to permeate water as a precursor for remineralization and to reduce pH value to an acceptable level for remineralization chemical dosing. When CO₂ is dissolved in water, it reacts with water to release hydrogen ions that make water acidic, lowering the pH value.

In an embodiment, the processor 202 may be configured to retrieve saturation index data of the first liquid stream based on the liquid stream data 104. Thereafter, the processor 202 may be configured to control the concentration of at least the first chemical compound of the set of chemical compounds in the first liquid stream based on the saturation index data. The saturation index data may correspond to the Langelier Saturation Index (LSI) which may be determined based on pH data, alkalinity, calcium hardness, and water temperature. In an embodiment, the processor 202 may be configured to determine whether the saturation index data of the first liquid stream is within a third threshold range. The third threshold range may include at least a minimum saturation index value of the first liquid stream, and a maximum saturation index value of the first liquid stream. In such a scenario, the minimum saturation index value, and the maximum saturation index value of the first liquid stream are determined based on saturation index data in the set of reference parameters. Thereafter, the processor 202 may be configured to control the output 106 of the first liquid stream based on the determination.

For example, the processor 202 may be configured to control the output 106 of the first liquid stream based on a determination that the saturation index data of the first liquid stream lies within the third threshold range. In such an embodiment, the output 106 corresponds to a storage of the first liquid stream. The output 106 may correspond to sending the re-mineralized water to water tanks. Alternatively, the processor 202 may be configured to control the output 106 of the first liquid stream based on a determination that the saturation index data of the first liquid stream is beyond the third threshold range associated with the potable water requirement. In such a case, the output 106 corresponds to the addition of at least the first chemical compound of the set of chemical compounds in the first liquid stream iteratively until the saturation index data is within the third threshold range.

In an example, the processor may be configured to control the dosing of at least the first chemical compound to achieve minimum alkalinity and hardness of the water requirement. As a result of the remineralization of permeate water performed as per embodiments described above, the water quality is enhanced, while minimizing chemical dosing and reducing energy consumption of the RO system 304 used for the treatment of the seawater.

In an embodiment, processor 202 may be configured to determine a quality score for the first liquid stream based on the set of parameters. Specifically, the processor 202 may be configured to determine the quality score based on the one or more water quality parameters. For example, the quality score corresponds to a score determined based on the one or more water quality parameters, chemical composition, pH level, microbial content, and the like. The processor 202 may be further configured to control the output 106 of the first liquid stream based on the determined quality score. In such an embodiment, the output 106 corresponds to a storage of the first liquid stream based on the determination that the quality score of the first liquid stream lies within a threshold range. Alternatively, the processor 202 may be configured to control the output 106 of the first liquid stream based on a determination that the quality score of the first liquid stream is beyond the threshold range associated with the potable water requirement. In such a case, the output 106 corresponds to the addition of at least the first chemical compound of the set of chemical compounds in the first liquid stream iteratively until the quality score is within the threshold range.

In an embodiment, system 102 may further include continuous monitoring of the re-mineralized water quality via a set of online analyzers and controlling the quality parameters. Further, the water quality parameters may be monitored according to the desired water quality parameters. In general, the water quality analyzers may be used for monitoring processes including water quality, providing process optimization and control. In an embodiment, the water quality analyzers may include computing programs that include computer-executable instructions, which are stored in the memory of a computing device and executed by a processor of the computing device. The computing device thus, enables continuous online monitoring of the quality of the re-mineralized water and also enables optimizing dosing of chemicals in the permeate water stream to achieve a desired optimum remineralization level thereby reducing chemical consumption.

In addition, the computing system is further configured to manage an event in which one or more quality parameters of the re-mineralized water are out of specification or to adjust chemical dosing to an optimized value to minimize chemical consumption. In effect, through the use of the computing system and capabilities of online monitoring and remineralization described above, the system 102 may be able to automatically or manually provide high-quality water at the output 106 of the SWRO system. In other embodiments, the system 102 may also include a controller for adjusting or regulating at least one parameter of the water treatment plant or a component of the water treatment plant.

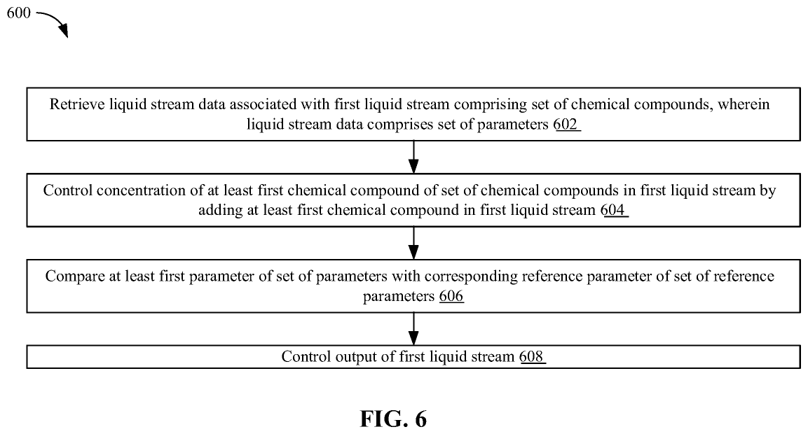

FIG. 6 is a flowchart that illustrates an exemplary method for remineralization of purified water, in accordance with an embodiment of the disclosure. FIG. 6 is explained in conjunction with elements from FIGS. 1, 2, 3, 4, and 5. With reference to FIG. 6, there is shown a flowchart 600. The operations of the exemplary method may be executed by any computing system, for example, by the system 102 of FIG. 1 or the processor 202 of FIG. 2. The operations of the flowchart 600 may start at 602.

At 602, liquid stream data may be retrieved. In an embodiment, the processor 202 may be configured to retrieve the liquid stream data 104 associated with the first liquid stream. The first liquid stream may include the set of chemical compounds, and the liquid stream data 104 may include the set of parameters. Details regarding the retrieval of the liquid stream data 104 are provided in FIG. 4.

At 604, the concentration of the first chemical compound may be controlled. In an embodiment, the processor 202 may be configured to control the concentration of at least the first chemical compound of the set of chemical compounds in the first liquid stream. The concentration of at least the first chemical compound may be controlled by adding at least the first chemical compound in the first liquid stream. Details regarding the control of the concentration of the first chemical compound are provided in FIG. 4.

At 606, the first parameter may be compared. In an embodiment, the processor 202 may be configured to compare at least the first parameter of the set of parameters with the corresponding reference parameter of the set of reference parameters. Details regarding the comparison are provided in FIG. 5.

At 608, the output 106 may be controlled. In an embodiment, the processor may be configured to control the output 106 of the first liquid stream based on the comparison. Details regarding the control of the output 106 are provided in FIG. 4 and FIG. 5.

Alternatively, the system 102 may include means for performing each of the operations described above. In this regard, according to an example embodiment, examples of means for performing operations may comprise, for example, the processor and/or a device or circuit for executing instructions or executing an algorithm for processing information as described above.

Various embodiments of the disclosure may provide a non-transitory computer-readable medium having stored thereon computer-executable instructions, which when executed by one or more processors (such as the processor 202), cause the one or more processors to carry out operations to operate a system (e.g., the system 102) for remineralization of the purified water. The instructions may cause the machine and/or computer to perform operations including, retrieving liquid stream data 104 associated with a first liquid stream including a set of chemical compounds, wherein the liquid stream data comprises a set of parameters. The operations may further include controlling a concentration of at least a first chemical compound of the set of chemical compounds in the first liquid stream by adding at least the first chemical compound in the first liquid stream. The operations may further include comparing at least a first parameter of the set of parameters with a corresponding reference parameter of a set of reference parameters based on the addition of at least the first chemical compound in the first liquid stream. The operations may further include controlling an output 106 of the first liquid stream based on the comparison.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of reactants and/or functions, it should be appreciated that different combinations of reactants and/or functions may be provided by alternative embodiments without departing from the scope of the appended claims. In this regard, for example, different combinations of reactants and/or functions than those explicitly described above are also contemplated as may be set forth in some of the appended claims. Although specific terms are employed herein, they are used in a generic and descriptive sense only and not for purposes of limitation.

What is claimed:

1. A system, comprising:
a memory configured to store a computer-executable instructions; and
one or more processors coupled to the memory, wherein the one or more processors are configured to execute the computer-executable instructions that cause the one or more processors to:
retrieve liquid stream data associated with a first liquid stream comprising a set of chemical compounds, wherein the liquid stream data comprises a set of parameters;
control a concentration of at least a first chemical compound of the set of chemical compounds in the first liquid stream by adding at least the first chemical compound in the first liquid stream;
compare at least a first parameter of the set of parameters with a corresponding reference parameter of a set of reference parameters based on the addition of at least the first chemical compound in the first liquid stream; and
control an output of the first liquid stream based on the comparison.

2. The system of claim 1, wherein the set of parameters are associated with at least one of: a chemical composition for each of the set of chemical compounds in the first liquid stream, a potential of hydrogen (pH) of the first liquid stream, a total dissolved solids (TDS) of the first liquid stream, or one or more water quality parameters of the first liquid stream.

3. The system of claim 1, wherein the one or more processors are further configured to:
determine a quality score for the first liquid stream based on the set of parameters; and
control the output of the first liquid stream based on the determined quality score.

4. The system of claim 1, wherein the set of reference parameters are associated with at least one of: a chemical composition for each of the set of chemical compounds in a reference liquid stream, a pH of the reference liquid stream, a TDS of the reference liquid stream, a charge balance of the set of chemical compounds in the reference liquid stream, one or more water quality parameters of the reference liquid stream, or a chloride ion ratio of the reference liquid stream.

5. The system of claim 1, wherein the one or more processors are further configured to determine whether at least the first parameter of the set of parameters is within a first threshold range, wherein the first threshold range comprises at least: a minimum value of the corresponding reference parameter, and a maximum value of the corresponding reference parameter.

6. The system of claim 5, wherein the one or more processors are further configured to control the output of the first liquid stream based on a determination that at least the first parameter of the set of parameters lies within the first threshold range, wherein the output corresponds to a storage of the first liquid stream.

7. The system of claim 5, wherein the one or more processors are further configured to control the output of the first liquid stream based on a determination that at least the first parameter of the set of parameters is greater than the maximum value of the corresponding reference parameter, or less than the minimum value of the corresponding reference parameter, wherein the output corresponds to the addition of at least the first chemical compound of the set of chemical compounds in the first liquid stream iteratively until at least the first parameter of the set of parameters is within the first threshold range.

8. The system of claim 1, wherein the one or more processors are further configured to:
retrieve pH data of the first liquid stream based on the liquid stream data; and
control the concentration of at least the first chemical compound of the set of chemical compounds in the first liquid stream based on the pH data.

9. The system of claim 8, wherein the one or more processors are further configured to:
determine whether the pH data of the first liquid stream is within a second threshold range, wherein the second threshold range comprises at least: a minimum pH value of the first liquid stream, and a maximum pH value of the first liquid stream, and wherein the minimum pH value, and the maximum pH value of the first liquid stream is determined based on pH data in the set of reference parameters; and
control the output of the first liquid stream based on the determination.

10. The system of claim 1, wherein the one or more processors are further configured to:
retrieve saturation index data for the first liquid stream based on the set of parameters; and
control the concentration of at least the first chemical compound of the set of chemical compounds in the first liquid stream based on the saturation index data.

11. The system of claim 10, wherein the one or more processors are further configured to:
determine whether the saturation index data for the first liquid stream is within a third threshold range, wherein the third threshold range comprises at least: a minimum saturation index value for the first liquid stream, and a maximum saturation index value for the first liquid stream, and wherein the minimum saturation index value and the maximum saturation index value is determined based on the saturation index data included in the set of reference parameters; and
control the output of the first liquid stream based on the determination.

12. The system of claim 1, wherein the one or more processors are further configured to control one or more valves to adjust the flow of the first liquid stream to add at least the first chemical compound.

13. A method, comprising:
retrieving liquid stream data associated with a first liquid stream comprising a set of chemical compounds, wherein the liquid stream data comprises a set of parameters;
controlling a concentration of at least a first chemical compound of the set of chemical compounds in the first liquid stream by adding at least the first chemical compound in the first liquid stream;
comparing at least a first parameter of the set of parameters with a corresponding reference parameter of a set of reference parameters based on the addition of at least the first chemical compound in the first liquid stream; and
controlling an output of the first liquid stream based on the comparison.

14. The method of claim 13, further comprising:
determining a quality score for the first liquid stream based on the set of parameters; and
controlling the output of the first liquid stream based on the determined quality score.

15. The method of claim 13, further comprising determining whether at least the first parameter of the set of parameters is within a first threshold range, wherein the first threshold range comprises at least: a minimum value of the corresponding reference parameter, and a maximum value of the corresponding reference parameter.

16. The method of claim 15, further comprising controlling the output of the first liquid stream based on a determination that at least the first parameter of the set of parameters lies within the first threshold range, wherein the output corresponds to a storage of the first liquid stream.

17. The method of claim 15, further comprising controlling the output of the first liquid stream based on a determination that at least the first parameter of the set of parameters is greater than the maximum value of the corresponding reference parameter, or less than the minimum value of the corresponding reference parameter, wherein the output corresponds to the addition of at least the first chemical compound of the set of chemical compounds in the first liquid stream iteratively until at least the first parameter of the set of parameters is within the first threshold range.

18. The method of claim 13, further comprising:
retrieving pH data of the first liquid stream based on the liquid stream data; and
controlling the concentration of at least the first chemical compound of the set of chemical compounds in the first liquid stream based on the pH data.

19. The method of claim 13, further comprising:
retrieving saturation index data for the first liquid stream based on the set of parameters; and
controlling the concentration of at least the first chemical compound of the set of chemical compounds in the first liquid stream based on the saturation index data.

20. A computer programmable product comprising a non-transitory computer-readable medium having stored thereon computer-executable instructions, which when executed by one or more processors, cause the one or more processors to carry out operations comprising:
retrieving liquid stream data associated with a first liquid stream comprising a set of chemical compounds, wherein the liquid stream data comprises a set of parameters;
controlling a concentration of at least a first chemical compound of the set of chemical compounds in the first liquid stream by adding at least the first chemical compound in the first liquid stream;
comparing at least a first parameter of the set of parameters with a corresponding reference parameter of a set of reference parameters based on the addition of at least the first chemical compound in the first liquid stream; and
controlling an output of the first liquid stream based on the comparison.
